(19) United States
(12) Patent Application Publication
(10) Pub. No.: US 2026/0332679 A1
(43) Pub. Date: Oct. 22, 2026

(54) EXTERNAL ARTIFICIAL INTELLIGENCE (AI) AGENT DISCOVERY

(71) Applicant: Cisco Technology, Inc., San Jose, CA (US)

(72) Inventors: David C. White, Jr., St. Petersburg, FL (US); Mohammed Izzat Hamzeh, Anna, TX (US)

(21) Appl. No.: 19/276,567

(22) Filed: Jul. 22, 2025

Related U.S. Application Data
(60) Provisional application No. 63/790,154, filed on Apr. 17, 2025.

(51) Int. Cl. H04L 67/51; H04L 67/30

(52) U.S. Cl. CPC H04L 67/51; H04L 67/30

(57) ABSTRACT

Techniques for enabling AI agents to self-register with an AI registration service and be validated, and their capabilities advertised to other AI agents are described. An AI agent registration service receives, from an AI agent, a request to initiate a registration process, the request includes information associated with the AI agent such as instructions to test that the AI agent can be reached and responds correctly to inputs. In response to receiving the information, the AI agent registration service tests that the AI agent can be reached and responds correctly to inputs. Based at least in part on the AI agent responding as expected, the AI agent registration service validates the AI agent, and stores a profile of the AI agent in a published AI agent registry such that the AI agent is discoverable by other agents.

### RELATED APPLICATIONS

This application claims priority to U.S. Provisional Patent Application No. 63/790,154 filed on Apr. 17, 2025, the entire contents of which are incorporated herein by reference and for all purposes.

### TECHNICAL FIELD

The present disclosure relates generally to techniques to provide an automated, scalable way that artificial intelligence (AI) agents can advertise their capabilities either within an enterprise organization or externally to the internet. An AI registration service registers and validates an AI agent. The AI agent is then advertised such that other AI agents can discover and communicate with it.

### BACKGROUND

Conventionally, enterprise organizations have been moving towards increasing automation of services. Many enterprise organizations provide publicly available application programming interfaces (APIs) for external entities to utilize to interact with the enterprise organization and its services. Additionally, the use of artificial intelligence (AI) is increasing exponentially worldwide. With this increase in the use of AI, AI agents are becoming more prevalent. An AI agent is capable of performing tasks, making decisions, and interacting with users in a natural way similar to a human in many respects. An AI agent can adapt to real-time data and context to autonomously diagnose problems, fulfill requests, assist with sales, and replace faulty products, among a variety of other purposes. AI agents observe their environment by collecting and processing data such as user inputs, performance metric, sensor data, etc. Using the collected data, an AI agent can leverage large language models to make a plan for what action(s) to take based on the collected data and the roles that define their behavior and type. AI agents can interface with systems, tools, and data sources to perform specific tasks. AI agents are also capable of delegating tasks or actions to other AI agents, as well as seeking clarification by prompting another entity, such as a human, for more input.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which an AI agent registration service registers, validates, and stores the profile of an AI agent for discovery by other AI agents.

FIG. 2 illustrates an example environment for agent-to-agent discovery and usage.

FIG. 3 illustrates an example process flow for automated AI agent registration, validation, and storage of the profile of the AI agent for discovery by other AI agents.

FIG. 4 illustrates a flow diagram of an example method for AI agent registration and validation.

FIG. 5 is a computer architecture diagram showing an example computer architecture for a device capable of executing program components that can be utilized to implement aspects of the various technologies presented herein.

### DESCRIPTION OF EXAMPLE EMBODIMENTS

### Overview

The present disclosure relates generally to registering and validating artificial intelligence (AI) agents and advertising their capabilities externally to the internet such that other AI agents can discover and communicate with them.

A method described herein may be performed at least in part by an artificial intelligence (AI) agent registration service. The method may include receiving, from an AI agent, a request to initiate a registration process, the request including information associated with the AI agent, wherein the information includes instructions to test that the AI agent can be reached and responds correctly to input. In response to receiving the information, the method also includes, testing that the AI agent can be reached and responds correctly to inputs. Based at least in part on the AI agent responding as expected, the method also includes validating the AI agent. Finally, the method includes storing a profile of the AI agent in a published AI agent registry such that the AI agent is discoverable by other agents. In some examples, the information associated with the AI agent further comprises one or more of; a description of the AI agent, capabilities of the AI agent, whether the AI agent is privately available to an enterprise organization for which the AI agent is associated or publicly available to AI agents that are external to the enterprise organization, input requirements to use the AI agent, how to access the AI agent, or examples of usage of the AI agent. Additionally, in some instances the AI agent registry is published at a known Uniform Resource Locator (URL) associated with an enterprise organization that is associated with the AI agent. In various instances, testing that the AI agent can be reached and responds correctly to inputs further comprises initiating a connection to the AI agent, inputting test data into the AI agent, and determining that the AI agent responds to the test data as expected. In some instances, the profile of the AI agent is a private profile, and the AI agent is discoverable by other AI agents that are withing a same enterprise organization as the AI agent. In other instances, the profile of the AI agent is a public profile, and the AI agent is discoverable by other AI agents that are within a same enterprise organization and other AI agents that are external to the enterprise organization. Finally, in some examples, the information that includes how to test that the AI agent can be reached and responds correctly to inputs further comprises an input schema specifying how inputs should be structured, and output schema specifying the expected structure of the output of the AI agent, and an evaluation test set mapped to a capability of the AI agent that indicates an expected output for a particular input.

Additionally, the techniques of at least the first method and the second method and any other techniques described herein, may be performed by a system and/or device having non-transitory computer-readable media storing computer-executable instructions that, when executed by one or more processors, performs the method(s) described above.

### Example Embodiments

As the proliferation of artificial intelligence (AI) increases exponentially worldwide, the use of AI agents is becoming increasingly prevalent. AI agents are capable of the following: observing their environment by gathering information and data via interfaces (e.g., APIs) user in puts, performance metric, sensors, etc. ; planning or evaluating and prioritizing actions based on tasks to be accomplished, roles that define an AI agents behavior or type of AI agent, leveraging language models (e.g., large language models (LLMs)) for reasoning abilities; and executing planned actions through interfaces to other systems, tools, or data sources, invoking other agents, or requesting addition information by prompting users for additional inputs. AI agents can adapt to real-time data and context to autonomously diagnose problems, fulfill requests, assist with sales, and replace faulty products, among a variety of other tasks. AI agents are also capable of delegating tasks or actions to other AI agents, as well as seeking clarification by prompting another entity for more input. Because AI agents are capable of directly interacting with other agents to solve problems, the detection, evaluation, and remediation of issues can be accomplished automatically and with little to no human intervention necessary. However, there is currently no means for AI agents to discover other AI agents associated with other enterprise organizations, in order to facilitate autonomous communication and action. Thus, as the capabilities of AI agents continues to grow, and more companies are investing in creating AI agents, there is a need to make those AI agents discoverable, both for internal and external users.

This disclosure describes an automated, scalable way that AI agents can advertise their capabilities either within an enterprise organization or external to the enterprise organization over the internet. An AI agent registration service provides a way for AI agents to register and be validated, and their capabilities advertised to other AI agents. These techniques provide a solution that allows any enterprise organization's AI agent to discover another enterprise organizations AI agent to facilitate agent-to-agent communications. This autonomous agent-to-agent discovery and usage is enabled by automated AI agent self-registration via the AI agent registration service, validation of the AI agent's operational capability by the AI agent by the registration service, and publication of an AI agent profile for discovery by the AI agent registration service.

As AI agents are created for an enterprise organization, the AI agents can self-register with the AI agent registration service for the enterprise organization. An AI agent contacts the AI agent registration service to initiate the process. The AI agent registration service requests information from the AI agent about itself. For example, the information may include a description of the AI agent, capabilities of the AI agent, whether the AI agent is to be privately available for discovery only within the enterprise organization, or whether the AI agent is to be publicly available for discovery by other AI agents that are external to the enterprise organization, input requirements to user the AI agent (e.g., account #, user ID and password, etc.), how to access the AI agent (e.g., fully qualified domain name (FQDN) or IP address), examples usage, and any optional requirements. Some of this information may be used to validate the AI agent and some of this information may published in an AI agent profile for other AI agents to use to connect to it. The AI agent registration service then validates the AI agent by initiating a connection to the agent and performing a task by using the “example usage” provided by the agent at registration time. The example usage includes information required to ‘test’ the agent operations along with the validation test criteria. This ensures that the AI agent can be reached and is responding correctly to its inputs. If the AI agent responds as expected, the AI agent registration service will validate the AI agent and add the AI agent (along with its profile) to its AI agent list by including it in the JSON dictionary available at http://agents.<root domain name> (e.g., https://agents.Cisco.com) so that the AI agent is available for other agents to discover and use. It should be noted that the URL described is an example and not meant to be limiting, any appropriate URL may be used.

Once the AI agent is registered, it is discoverable by other agents by querying the URL. For example, another AI agent can query the URL, obtain a list of AI agents and their capabilities, identify an appropriate agent, and connect to the appropriate agent to exchange information in order to accomplish a required task. Thus, in summary, the techniques described herein enable the self-registration of an AI agent with an AI registration service that then publishes a profile of the AI agent (either privately or publicly) of other AI agents to discover and connect with in order to automatically, without human intervention, accomplish a task. Although the techniques described herein use examples that are fully automated without any human intervention, it should be understood that if an enterprise organization desires to have human input, approval, etc. at any point in the process, the process can easily accommodate any amount of desired human intervention.

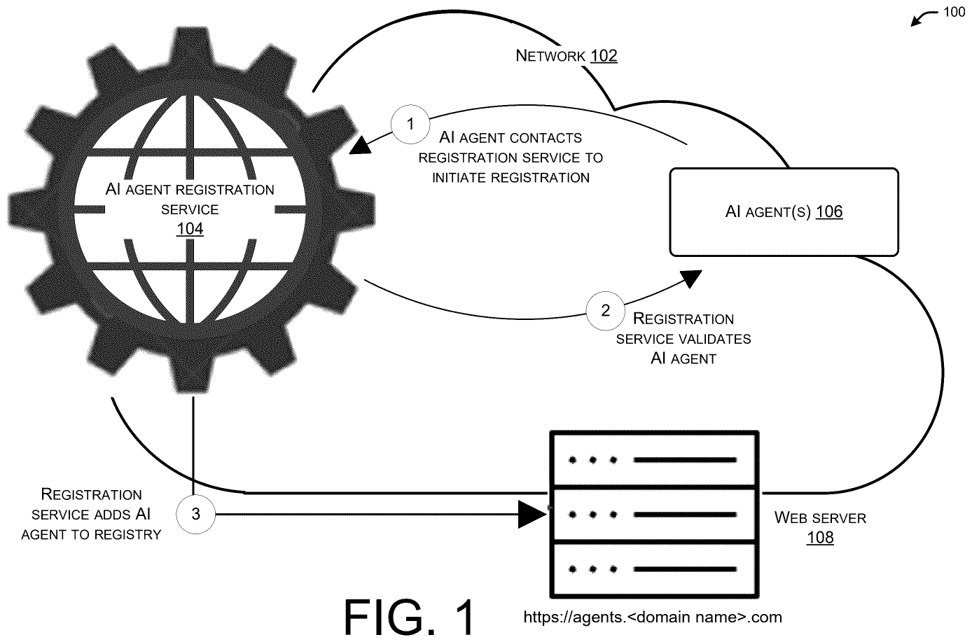

FIG. 1 illustrates a system-architecture diagram of an environment 100 in which an AI agent registration service registers, validates, and stores the profile of an AI agent for discovery by other AI agents.

The environment 100 may include a network 102 implemented by any viable communication technology, such as wired and/or wireless modalities and/or technologies. The network 102 may be any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The network 102 may include devices, virtual resources, or other nodes that relay packets from one network segment to another by nodes in the computer network. The network 102 may include multiple devices that utilize the network layer (and/or session layer, transport layer, etc.) in the OSI model for packet forwarding, and/or other layers.

Although not illustrated is should be understood that although network 102 may contain various kinds of security devices, other devices such as routers, switches, gateways, smart NICs, NICs, ASICs, FPGAs, servers, and/or any other type of appropriate type of device may also be included in network 102. Further, the network 102 may include virtual resources, such as VMs, containers, and/or other virtual resources. However, the network 102 may be of a different type of architecture, such as a WAN, IoT network, cellular network, or any other type of network.

Environment 100 also includes an AI agent registration service 104. The AI agent registration service 104 is enabled to register and validate various AI agent(s) 106 for an enterprise organization via network 102 and publish the AI agent profile in a registry of discoverable AI agents stored in a web server 108. For example, when an AI agent(s) 106 is created for an enterprise organization, at (1) the AI agent(s) 106 contacts the AI agent registration service 104 to initiate the registration process. Once contacted, the AI agent registration service 104 requests information from the AI agent(s) 106. This information may include a description of the AI agent, capabilities of the AI agent, whether the AI agent is to be privately available for discovery only within the enterprise organization, or whether the AI agent is to be publicly available for discovery by other AI agents that are external to the enterprise organization, input requirements to user the AI agent (e.g., account #, user ID and password, etc.), how to access the AI agent (e.g., fully qualified domain name (FQDN) or IP address), examples usage, and any optional requirements. Some of this information may be used to validate the AI agent and some of this information may published in an AI agent profile for other AI agents to use to connect to it. At (2) the AI agent registration service 104 validates the AI agent. To validate the AI agent 106, the AI Agent registration service 104 initiates a connection to the AI agent 106 and performs a task by using the ‘example usage’ provided by the agent at registration time. The example usage includes information required to test the operation of the AI agent 106 along with the validation test criteria. This ensures that the AI agent 106 can be reached and is responding correctly to its inputs. If the AI agent 106 responds as expected, the AI agent registration service 104 will validate the AI agent 106 and add a profile of the AI agent 106 to its AI agent registry list by including it in the JSON dictionary available at http://agents.<domain name>.com so that the AI agent 106 is available for other agents to discover and use. In addition, the information received from AI agent 106 will specify whether AI agent 106 should be published in the registry with a private or public profile. If AI agent 106 is to be published with a private profile, only other AI agents associated with a same enterprise organization as AI agent 106 will be able to discover and use AI agent 106. Alternately, if AI agent 106 is to be published with a public profile, not only will AI agents associated with a same enterprise organization be able to discover AI agent 106, AI agents external to the enterprise organization will also be able to discover AI agent 106.

In summary, an AI agent registration service may be analogized to a person-to-person telephone call facilitated by a telephone number listing. Traditionally, when an entity signed up for telephone services, the entities telephone number would be listed in a phone book, or later an online listing of telephone numbers along with a name of who the telephone number belongs to, and possibly even an advertisement about what kind of services a company that has a particular phone number may offer. When a person desires services that the company offers, the person looks up the company's telephone number, calls it, talks to another person (e.g., an employee, i.e., an agent of the company) and requests a pizza delivery (or whatever service they desire that the company offers). The person ordering the pizza and the employee exchange information (e.g., pizza toppings, size of the pizza, delivery address, etc.) in order to accomplish the task of pizza delivery. The techniques described herein are similar to person to person contact via a telephone, where the telephone number is listed in a phone book, but instead the techniques describe AI agent to AI agent contact via an online AI agent registry.

An example JSON format of how a registry may look for a troubleshooting agent, a sales agent, an RMA agent and a network security agent. Note, the following is an example and not meant to be limiting.

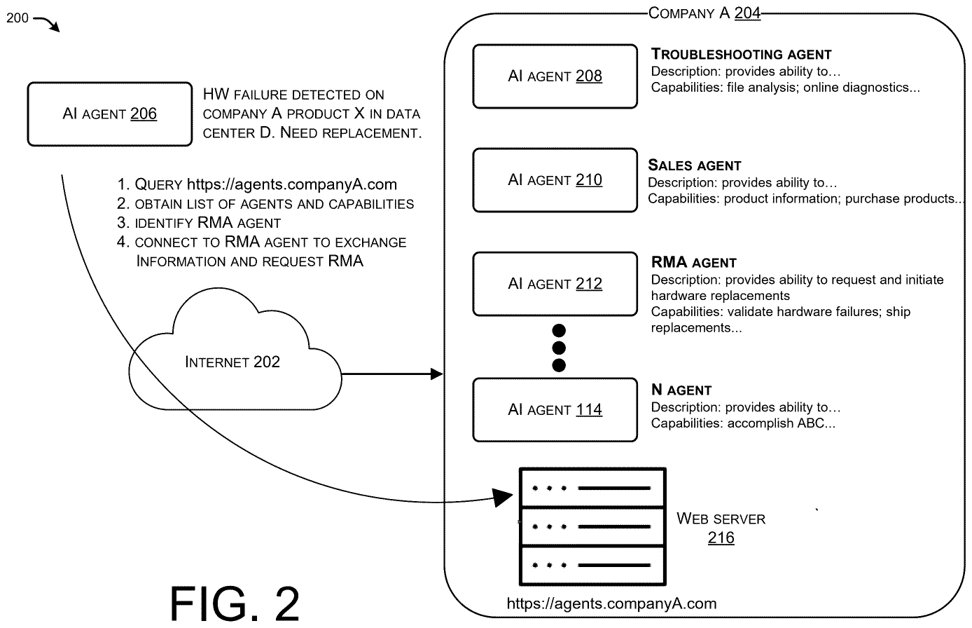

FIG. 2 illustrates an example environment 200 for agent-to-agent discovery and usage.

Environment 200 includes the internet 202 that represents multiple interconnected networks used for electronic communications between client devices. Network 102 illustrated in FIG. 1 may be the same or similar to one or more networks interconnected within the internet 202. Environment 200 also includes an enterprise organization, company A 204. Company A 204 may be any type of enterprise organization that owns one or more AI agents available for connection with other AI agents, either internal or external. For purposes of example, company A 204 is illustrated as being an enterprise organization that designs, manufactures, and sells networking hardware. It should be understood to those skilled in the art that this is an example and not meant to be limiting. Company A 204 may represent any type of enterprise organization. Environment 200 also includes an AI agent 206. AI agent 206 is an AI agent external to company A 204. AI agent 206 may be the same or similar to AI agent 106 as described with reference to FIG. 1. AI agent 206 is illustrated as an AI agent that is used to monitor and troubleshoot a network for an enterprise organization. It should be noted that this by example and not limitation. The techniques described herein for agent discovery and usage may be implemented by any type of AI agent.

Environment 200 also includes multiple AI agents owned by company A 204, such as AI agent 208, AI agent 210, AI agent 212, and up to AI agent N 114. Again, this is meant as an example and not a limitation, an enterprise organization may own more or less AI agents, and the AI agents may be capable of performing similar or dissimilar tasks. In the example illustrated in environment 200, AI agent 208 is a troubleshooting agent that provides the ability to troubleshoot a network problem and is capable of executing such tasks as file analysis, online diagnostics, etc. AI agent 210 is a sales agent that provides assistance with to customers to buy products company A 204 sells, and is capable of executing task such as providing a customer with product information, facilitating the sale of products, etc. AI agent 212 is a return merchandise authorization (RMA) agent that provides the ability to request and initiate hardware replacements, and is capable of executing task such as validating hardware failures, shipping replacement products, etc. As illustrated with AI agent 114, company A 204 may own multiple other AI agents that provide other services and are capable of executing other tasks.

Finally, environment 200 includes a web server 216 of company A 204 that can be reached at https://agents.companyA.com. Web server 216 stores the profiles of registered AI agents owned by company A 204 and available for discovery by other AI agents. For examples, Web server 216 will contain the profiles of AI agent 208, AI agent 210, AI agent 212, up to AI agent 114. A profile of an AI agent stored in web server 216 may include information such as a description of the AI agent, capabilities of the AI agent (each capability may be defined with a unique name and detailed description, enabling effective embedding and semantic search), whether the AI agent is public or private (i.e., available to other AI agents external to company A 204, or only available to other AI agents internal to company A 204), input requirements to use the AI agent (e.g., account #, user ID and password, etc.), how to access the AI agent (FQDN or IP), and any other optional requirements. The requirements to use the AI agent may be divided into two parts, input schema and authentication. The input schema defines the structure of the data the AI agent expects, and the authentication may be a separate object for managing access and security. Additionally, the profile may include an output schema, an openAPI schema detailing the expected structure of the AI agent's output, ensuring that outputs are easily parsable by any consuming code. The information stored in the web server 216 may be JSON format.

Consider a practical example of automated agent-to-agent discovery and usage with reference to FIG. 2. AI agent 206, an AI agent tasked with monitoring and troubleshooting the network of an enterprise organization, is monitoring the network for an enterprise organization and detects a hardware failure on a device in data center D. AI agent 206 looks in an inventory management system and determines that the device with the failure is a product X device manufacture by Company A 204 and is under a support contract. AI agent 206 then reaches out to see if there are any available AI agent with which AI agent 206 can work to remedy the failure. To do this, AI agent queries the web server 216 at http://agents.<domain name>.com, which in the example illustrated in FIG. 2 is http://agents.companyA.com to obtain a list of registered AI agents available at company A 204. Note, the available agents available for automated agent-to-agent discovery stored in web server 216 have been registered with an AI agent registration service for company A 204 as described above with reference to FIG. 1. AI agent 206 looks at the capabilities of the AI agents available at company A 204 (AI agent 208—AI agent N). AI agent 208 is a troubleshooting agent, but AI agent 206 has already done the troubleshooting, so AI agent 208 is not needed at this time. AI agent 210 is a sales agent, but the device with the failure has a support contract, so a new device does not need to be purchased, thus, AI agent 210 is not needed at this time. AI agent 212 is an RMA agent which can initiate hardware replacements, thus, AI agent 212 is the correct AI agent to connect to. Thus, once AI agent 206 identifies AI agent 212 as the correct AI agent to assist in the current situation, AI agent 206 connects to AI agent 212 and exchanges information necessary to initiate the RMA (e.g., serial number (SN), contract, failure reason, shipping address, etc.). In some examples, AI agent 206 may require a valid digital support contract with company A for certain services in order to connect with a particular AI agent owned by Company A. For example, AI agent 206 might be authorized to access the sales agent AI agent 210 and the RMA agent AI agent 212 but not the troubleshooting agent AI agent 208. Thus, if AI agent 206 attempts to connect with AI agent 208, the troubleshooting agent, during an information exchange between the AI agents, it will be determined that AI agent 206 does not have the approval to use AI agent 208 and authorization will be denied.

In should be understood by one skilled in the art that although the examples described here are described with full automation, the AI agent registry may also be discovered with any amount of human intervention by a human agent and not exclusively by an AI agent.

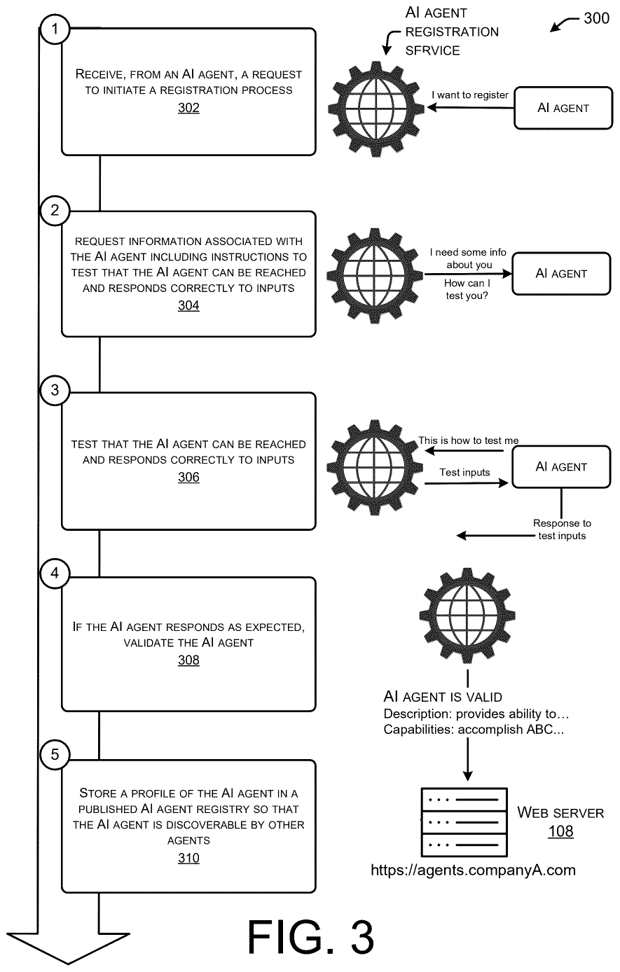

FIG. 3 illustrates a flow diagram 300 of an example process flow for automated AI agent registration, validation, and storage of the profile of the AI agent for discovery by other AI agents.

At 302, an AI agent registration service receives a request from an AI agent to initiate a registration process. For example, with reference to FIG. 1 the AI agent 106 contacts AI agent registration service 104 to initiate a registration process. Once the AI agent is created, the AI agent can automatically initiate the self-registration process with the AI agent registration service.

At 304, the AI agent registration service request information associated with the AI agent including how to test that the AI agent can be reached and responds correctly to inputs. For example, with reference to FIG. 1 the AI agent registration service 104 requests information from AI agent 106 that includes a description of AI agent 106, the capabilities of AI agent 106, whether AI agent 106 is to be published as a private (only available to other internal agents) or public (also available to external agents) agent, input requirements to use AI agent 106 (e.g., account #, user ID and PW, etc.), optional requirements, how to access the AI agent 106 (FQDN or IP), and example usage of AI agent 106. Alternately or in addition, in some instances, The AI agent may include its information with its request to register as described in the above step at 302. Thus, eliminating the need for the AI registration service to specifically request this information.

At 306, in response to receiving the information, the AI registration service tests that the AI agent can be reached and responds correctly to inputs. For example, with reference to FIG. 1 the AI Agent registration service 104 initiates a connection to the AI agent 106 and performs a task by using the ‘example usage’ provided by the agent at registration time. The example usage includes information required to test the operation of the AI agent 106 along with the validation test criteria. This ensures that the AI agent 106 can be reached and is responding correctly to its inputs.

At 308, if the AI agent responds as expected, the AI agent registration service validates the AI agent. For example, with reference to FIG. 1 if the AI agent 106 can be reached by AI agent registration service 104 and the AI agent 106 responds to test inputs as expected, the AI agent registration service 104 validates the AI agent 106.

At 310, the AI agent registration service stores a profile of the AI agent in a published AI agent registry so that the AI agent is discoverable by other agents. For example, with reference to FIG. 1 the AI agent registration service 104 stores the profile of AI agent 106 in the web server 108 that can be found at https://agents.companyA.com by other AI agents. In another example with reference to FIG. 2, the profiles of each AI agent owned by company A 204 is published (either privately or publicly) in web server 216. The profiles of the AI agent stored in web server 216 are then discoverable by external AI agents 206 (if the profile is public) or other AI agents owned by company A 204 such as AI agent 208, AI agent 210, AI gent 212, up through AI agent 114.

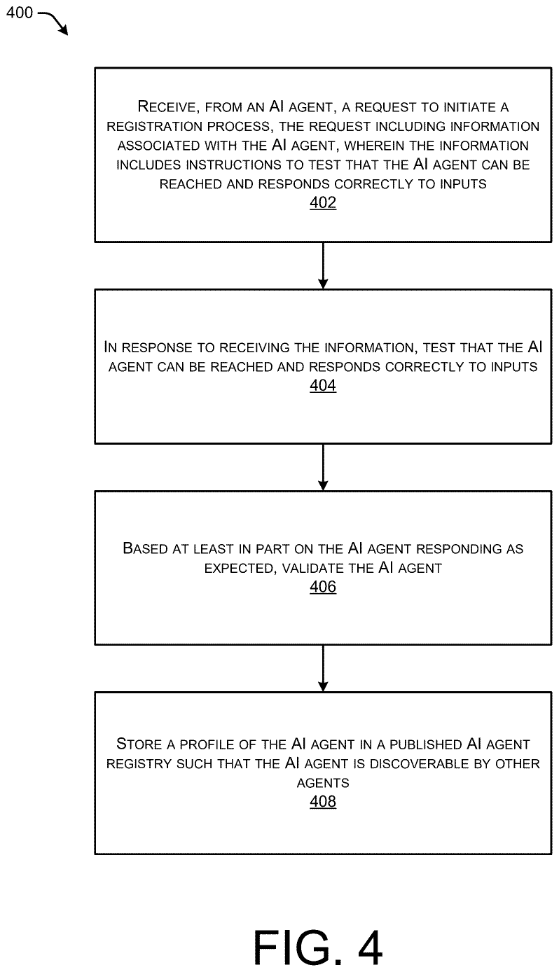

FIG. 4 illustrates a flow diagrams of an example method 400 that illustrates aspect of the functions performed at least partly by the devices described in FIGS. 1-3, such as the AI agent registration service 104. The logical operations described herein with respect to FIG. 4 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIG. 4 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

In some instances, the steps of methods 400 may be performed by a device and/or a system of devices that includes one or more processors and one or more non-transitory computer-readable media storing computer-executable instructions that, when executed by the one or more processors, cause the one or more processors to perform operations of method 400.

At operation 402, an AI agent registration service receives a request to initiate a registration process from an AI agent. The request includes information associated with the AI agent such as how to test that the AI agent can be reached and responds correctly to inputs. For example, with reference to FIG. 1 at (1) the AI agent 106 contacts AI agent registration service 104 to initiate an AI agent registration process and the AI agent 106 sends the AI agent registration service 104 its information. This information includes a description of AI agent 106, the capabilities of AI agent 106, whether AI agent 106 is to be published as a private (only available to other internal agents) or public (also available to external agents) agent, input requirements to use AI agent 106 (e.g., account #, user ID and PW, etc.), optional requirements, how to access the AI agent 106 (FQDN or IP), and example usage of AI agent 106. Once the AI agent is created, the AI agent can automatically initiate the self-registration process with the AI agent registration service.

At operation 404, in response to receiving the information, the AI agent registration service test that the AI agent can be reached and responds correctly to inputs. For example, with reference to FIG. 1 the AI Agent registration service 104 initiates a connection to the AI agent 106 and performs a task by using the ‘example usage’ provided by the agent at registration time. The example usage includes information required to test the operation of the AI agent 106 along with the validation test criteria. This ensures that the AI agent 106 can be reached and is responding correctly to its inputs.

At operation 406, based at least in part on the AI agent responding as expected, the AI agent registration service validates the AI agent. For example, with reference to FIG. 1 at (2) if the AI agent 106 can be reached by AI agent registration service 104 and the AI agent 106 responds to test inputs as expected, the AI agent registration service 104 validates the AI agent 106.

At operation 408, the AI agent registration service stores a profile of the AI agent in a published AI agent registry such that the AI agent is discoverable by other agents. For example, with reference to FIG. 1 at (3) the AI agent registration service 104 stores the profile of AI agent 106 in the web server 108 that can be found at https://agents.companyA.com by other AI agents. In another example with reference to FIG. 2, the profiles of each AI agent owned by company A 204 is published (either privately or publicly) in web server 216. The profiles of the AI agent stored in web server 216 are then discoverable by external AI agents 206 (if the profile is public) or other AI agents owned by company A 204 such as AI agent 208, AI agent 210, AI gent 212, up through AI agent 114.

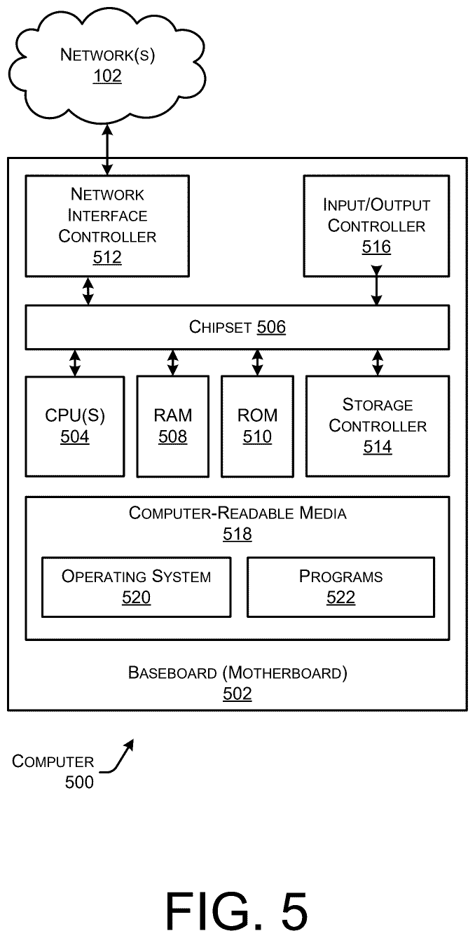

FIG. 5 shows an example computer architecture for a device capable of executing program components for implementing the functionality described above. The computer architecture shown in FIG. 5 illustrates any type of computer 500, such as a conventional server computer, workstation, desktop computer, laptop, tablet, network appliance, e-reader, smartphone, or other computing device, and can be utilized to execute any of the software components presented herein.

As described herein, the computer 500 may be any type of device, such as AI agent registration service 104, AI agent(s) 106, or web server 108. Thus, the computer 500 may, in some examples, correspond to any device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 500 includes a baseboard 502, or “motherboard,” which is a printed circuit board to which a multitude of components or devices can be connected by way of a system bus or other electrical communication paths. In one illustrative configuration, one or more central processing units (“CPUs”) 504 operate in conjunction with a chipset 506. The CPUs 504 can be standard programmable processors that perform arithmetic and logical operations necessary for the operation of the computer 500.

The CPUs 504 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 506 provides an interface between the CPUs 504 and the remainder of the components and devices on the baseboard 502. The chipset 506 can provide an interface to a RAM 508, used as the main memory in the computer 500. The chipset 506 can further provide an interface to a computer-readable storage medium such as a read-only memory (“ROM”) 510 or non-volatile RAM (“NVRAM”) for storing basic routines that help to start up the computer 500 and to transfer information between the various components and devices. The ROM 510 or NVRAM can also store other software components necessary for the operation of the computer 500 in accordance with the configurations described herein.

The computer 500 can operate in a networked environment using logical connections to remote computing devices and computer systems through a network, such as the network 102. The chipset 506 can include functionality for providing network connectivity through a NIC 512, such as a gigabit Ethernet adapter. The NIC 512 is capable of connecting the computer 500 to other computing devices over the network 102. It should be appreciated that multiple NICs 512 can be present in the computer 500, connecting the computer to other types of networks and remote computer systems.

The computer 500 can be connected to a storage device 518 that provides non-volatile storage for the computer. The storage device 518 can store an operating system 520, programs 522, and data, which have been described in greater detail herein. The storage device 518 can be connected to the computer 500 through a storage orchestrator 514 connected to the chipset 506. The storage device 518 can consist of one or more physical storage units. The storage orchestrator 514 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 500 can store data on the storage device 518 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 518 is characterized as primary or secondary storage, and the like.

For example, the computer 500 can store information to the storage device 518 by issuing instructions through the storage orchestrator 514 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 500 can further read information from the storage device 518 by detecting the physical states or characteristics of one or more particular locations within the physical storage units.

In addition to the mass storage device 518 described above, the computer 500 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 500. In some examples, the operations performed by the AI agent registration service 104, the AI agent(s) 106, the web server 108, and or any components included therein, may be supported by one or more devices similar to computer 500. Stated otherwise, some or all of the operations performed by AI agent registration service 104, the AI agent(s) 106, the web server 108, and or any components included therein, may be performed by one or more computer devices 500.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 518 can store an operating system 520 utilized to control the operation of the computer 500. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 518 can store other system or application programs and data utilized by the computer 500.

In one embodiment, the storage device 518 or other computer-readable storage media is encoded with computer-executable instructions which, when loaded into the computer 500, transform the computer from a general-purpose computing system into a special-purpose computer capable of implementing the embodiments described herein. These computer-executable instructions transform the computer 500 by specifying how the CPUs 504 transition between states, as described above. According to one embodiment, the computer 500 has access to computer-readable storage media storing computer-executable instructions which, when executed by the computer 500, perform the various processes described above with regard to FIGS. 1-4. The computer 500 can also include computer-readable storage media having instructions stored thereupon for performing any of the other computer-implemented operations described herein.

The computer 500 can also include one or more input/output orchestrators 516 for receiving and processing input from a number of input devices, such as a keyboard, a mouse, a touchpad, a touch screen, an electronic stylus, or other type of input device. Similarly, an input/output orchestrator 516 can provide output to a display, such as a computer monitor, a flat-panel display, a digital projector, a printer, or other type of output device. It will be appreciated that the computer 500 might not include all of the components shown in the Figures, can include other components that are not explicitly shown in FIG. 5, or might utilize an architecture completely different than that shown in FIG. 5.

As described herein, the computer 500 may comprise one or more of the AI agent registration service 104, the AI agent(s) 106, the web server 108 and/or any other device. The computer 500 may include one or more hardware processors 504 (processors) configured to execute one or more stored instructions. The processor(s) 504 may comprise one or more cores. Further, the computer 500 may include one or more network interfaces configured to provide communications between the computer 500 and other devices, such as the communications described herein as being performed by the AI agent registration service 104, the AI agent(s) 106, the web server 108. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 522 may comprise any type of programs or processes to perform the techniques described in this disclosure.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method performed at least in part by an artificial intelligence (AI) agent registration service for registering an AI agent, the method comprising:
receiving, from an AI agent, a request to initiate a registration process, the request including information associated with the AI agent, wherein the information includes instructions to test that the AI agent can be reached and responds correctly to inputs;
in response to receiving the information, testing that the AI agent can be reached and responds correctly to inputs;
based at least in part on the AI agent responding as expected, validating the AI agent; and
storing a profile of the AI agent in a published AI agent registry such that the AI agent is discoverable by other agents.

2. The method of claim 1, wherein the information associated with the AI agent further comprises one or more of:
a description of the AI agent;
capabilities of the AI agent;
whether the AI agent is privately available to an enterprise organization for which the AI agent is associated or publicly available to AI agents that are external to the enterprise organizations;
input requirements to use the AI agent;
how to access the AI agent; or
examples of usage of the AI agent.

3. The method of claim 1, wherein the AI agent registry is published at a known Uniform Resource Locator (URL) associated with an enterprise organization that is associated with the AI agent.

4. The method of claim 1, wherein testing that the AI agent can be reached and responds correctly to inputs further comprises:
initiating a connection to the AI agent;
inputting test data into the AI agent; and
determining that the AI agent responds to the test data as expected.

5. The method of claim 1, wherein the profile of the AI agent is a private profile, and the AI agent is discoverable by other AI agents that are within a same enterprise organization as the AI agent.

6. The method of claim 1, wherein the profile of the AI agent is a public profile, and the AI agent is discoverable by other AI agents that are within a same enterprise organization and other AI agents that are external to the enterprise organization.

7. The method of claim 1, wherein the information that includes how to test that the AI agent can be reached and responds correctly to inputs further comprises:
an input schema specifying how inputs should be structured;
an output schema specifying an expected structure of the output of the AI agent; and
an evaluation test set mapped to a capability of the AI agent that indicates an expected output for a particular input.

8. A system comprising:
one or more processors; and
one or more computer-readable media storing computer-executable instructions that, when executed by the one or more processors, cause the one or more processors to perform operations comprising:
receiving, by an artificial intelligence (AI) agent registration service and from an AI agent, a request to initiate a registration process, the request including information associated with the AI agent, wherein the information includes instructions to test that the AI agent can be reached and responds correctly to inputs;
in response to receiving the information, testing, by the AI agent registration service, that the AI agent can be reached and responds correctly to inputs;
based at least in part on the AI agent responding as expected, validating, by the AI agent registration service, the AI agent; and
storing, by the AI agent registration service, a profile of the AI agent in a published AI agent registry such that the AI agent is discoverable by other agents.

9. The system of claim 8, wherein the information associated with the AI agent further comprises one or more of:
a description of the AI agent;
capabilities of the AI agent;
whether the AI agent is privately available to an enterprise organization for which the AI agent is associated or publicly available to AI agents that are external to the enterprise organizations;
input requirements to use the AI agent;
how to access the AI agent; or
examples of usage of the AI agent.

10. The system of claim 8, wherein the AI agent registry is published at a known Uniform Resource Locator (URL) associated with an enterprise organization that is associated with the AI agent.

11. The system of claim 8, wherein testing that the AI agent can be reached and responds correctly to inputs further comprises:
initiating a connection to the AI agent;
inputting test data into the AI agent; and
determining that the AI agent responds to the test data as expected.

12. The system of claim 8, the operations further comprising transmitting, by the AI agent registration service and to the AI agent, a request for the information associated with the AI agent.

13. The system of claim 8, wherein the profile of the AI agent is a public profile, and the AI agent is discoverable by other AI agents that are within a same enterprise organization and other AI agents that are external to the enterprise organization.

14. The system of claim 8, wherein the information that includes how to test that the AI agent can be reached and responds correctly to inputs further comprises:
an input schema specifying how inputs should be structured;
an output schema specifying an expected structure of the output of the AI agent; and
an evaluation test set mapped to a capability of the AI agent that indicates an expected output for a particular input.

15. One or more non-transitory computer-readable media storing instructions that, when executed, cause one or more processors to perform operations comprising:
receiving, by an artificial intelligence (AI) agent registration service and from an AI agent, a request to initiate a registration process, the request including information associated with the AI agent, wherein the information includes instructions to test that the AI agent can be reached and responds correctly to inputs;
in response to receiving the information, testing, by the AI agent registration service, that the AI agent can be reached and responds correctly to inputs;
based at least in part on the AI agent responding as expected, validating, by the AI agent registration service, the AI agent; and
storing, by the AI agent registration service, a profile of the AI agent in a published AI agent registry such that the AI agent is discoverable by other agents.

16. The one or more non-transitory computer-readable media of claim 15, wherein the information associated with the AI agent further comprises one or more of:
a description of the AI agent;
capabilities of the AI agent;
whether the AI agent is privately available to an enterprise organization for which the AI agent is associated or publicly available to AI agents that are external to the enterprise organizations;
input requirements to use the AI agent;
how to access the AI agent; or
examples of usage of the AI agent.

17. The one or more non-transitory computer-readable media of claim 15, wherein the AI agent registry is published at a known Uniform Resource Locator (URL) associated with an enterprise organization that is associated with the AI agent.

18. The one or more non-transitory computer-readable media of claim 15, wherein testing that the AI agent can be reached and responds correctly to inputs further comprises:
initiating a connection to the AI agent;
inputting test data into the AI agent; and
determining that the AI agent responds to the test data as expected.

19. The one or more non-transitory computer-readable media of claim 15, wherein the profile of the AI agent is a private profile, and the AI agent is discoverable by other AI agents that are within a same enterprise organization as the AI agent.

20. The one or more non-transitory computer-readable media of claim 15, wherein the information that includes how to test that the AI agent can be reached and responds correctly to inputs further comprises:
an input schema specifying how inputs should be structured;
an output schema specifying an expected structure of the output of the AI agent; and
an evaluation test set mapped to a capability of the AI agent that indicates an expected output for a particular input.
